(19) United States
(12) Patent Application Publication
(10) Pub. No.: US 2018/0347440 A1
(43) Pub. Date: Dec. 6, 2018

(54) EXHAUST SYSTEM SUPPORT STRUCTURE

(71) Applicant: FUTABA INDUSTRIAL CO., LTD., Aichi (JP)

(72) Inventors: Shohei Shimizu, Aichi (JP); Tomohiro Yoshino, Aichi (JP)

(21) Appl. No.: 15/761,642

(22) PCT Filed: Jan. 26, 2016
(86) PCT No.: PCT/JP2016/052140

§ 371 Date: Mar. 20, 2018

(51) Int. Cl. F01N 13/18; B60K 13/04; F01N 1/02

(52) U.S. Cl. CPC F01N 13/1805; F01N 1/023; B60K 13/04

(57) ABSTRACT

A support member is fixed to an outer circumferential surface of an exhaust pipe with a bracket. The bracket comprises a main body and a flange portion. The main body has a cylindrical shape, whose diameter increases gradually. The flange portion is arranged so as to extend outward from a large-diameter end, which is an end having a larger diameter in the main body. The flange portion is joined to the outer circumferential surface of the exhaust pipe. The support member comprises a rod-like end, which is an end in a rod-like shape. The support member is joined to a rim portion of an opening of a small-diameter end, which is one end having a smaller diameter in the main body, such that the rod-like end is inserted into the opening.

### TECHNICAL FIELD

The present disclosure relates to an exhaust system support structure.

### BACKGROUND ART

Patent Document 1 discloses an exhaust system support structure for holding an exhaust system composed of a muffler, an exhaust pipe and so forth, to a main body of a vehicle. Such an exhaust system support structure comprises a heat shielding plate formed in a bowl-like shape. A peripheral edge of the heat shielding plate is joined to an outer circumferential surface of the muffler of the vehicle.

A part of a main rod, which is an L-shaped rod-like member, is joined to an upper wall of the heat shielding plate (a bottom section thereof). Specifically, the part of the main rod is joined to a surface of the upper wall of the heat shielding plate so as to extend along the upper wall thereof. Also, a projecting portion is formed so as to bend from one end of a joined section of the main rod, and to extend in a direction substantially perpendicular to the upper wall.

In such an exhaust system support structure, the muffler is held to the main body of the vehicle such that the projecting portion of the main rod is fitted into, and thus fixed to, one hole portion of two hole portions formed in a rubber portion having a substantially plate-like shape, and a rod-like portion coupled to the main body of the vehicle is fitted into, and thus fixed to, the other hole portion.

Additionally, an auxiliary rod having the same shape as the main rod is joined to the upper wall of the heat shielding plate. A projecting portion of the auxiliary rod bends from one end of a joined section of the auxiliary rod. The projection portion of the auxiliary rod is shorter than that of the main rod and is joined to a side wall of the main rod.

### PRIOR ART DOCUMENTS

### Patent Documents

Patent Document 1: Japanese Unexamined Patent Application Publication No. 2005-220852

### SUMMARY OF THE INVENTION

### Problems to be Solved by the Invention

However, in such a configuration of the exhaust system support structure described in Patent Document 1, when external force is applied to the main rod, stress is likely to be concentrated in joining portions of the exhaust system support structure. Specifically, stress is likely to be concentrated in the joining portion between the heat shielding plate and the main rod, in other words, the joining portion between the muffler as an exhaust pipe forming an exhaust flow passage and the main rod as a support member fixed to the outer circumferential surface of the exhaust pipe with the heat shielding plate.

In one aspect of the present disclosure, it is desirable that stress is inhibited from being concentrated in the joining portions between the exhaust pipe and the support member.

### Means for Solving the Problems

Provided in one embodiment of the present disclosure is an exhaust system support structure comprising an exhaust pipe, a bracket, and a support member. The exhaust pipe forms an exhaust flow passage. The support member is fixed to an outer circumferential surface of the exhaust pipe with the bracket. The bracket comprises a main body and a flange portion. The main body has a cylindrical shape, whose diameter increases gradually. The flange portion is arranged so as to extend outward from a large-diameter end, which is an end having a larger diameter in the main body. The flange portion is joined to the outer circumferential surface of the exhaust pipe. The support member comprises a rod-like end, which is an end in a rod-like shape. The support member is joined to a rim portion of an opening of a small-diameter end, which is one end having a smaller diameter in the main body, such that the rod-like end is inserted into the opening.

In such a configuration, the diameter of the main body of the bracket gradually increases from a joining portion of the bracket with the support member toward a joining portion thereof with the exhaust pipe. As a result, stress caused by external force, which is applied to the support member, can be dispersed.

In one embodiment of the present disclosure, in the support member, an axial circumference of the rod-like end may be entirely joined to the main body of the bracket.

In such a configuration, stress can be inhibited from being concentrated in a joining portion between the support member and the bracket.

However, if the circumference of the support member is not entirely joined to the main body, an end comes to exist in the joining portion in the axial circumference of the rod-like end and, when external force is applied to the support member, stress is likely to be concentrated in such an end.

In contrast, in the aforementioned configuration, no end exists in the joining portion in the axial circumference of the rod-like end. For this reason, as compared with a case where the circumference of the support member is not entirely joined, in other words, where only a part of the circumference of the support member is joined, stress can be inhibited from being concentrated in the joining portion between the support member and the bracket.

In one embodiment of the present disclosure, the flange portion may be circularly arranged along a rim portion of the large-diameter end of the bracket. The circular circumference of the flange portion is entirely joined to the outer circumferential surface of the exhaust pipe.

In such a configuration, no end exists in the joining portion in the circular circumference of the flange portion. For this reason, as compared with a case where the circumference of the flange portion is not entirely joined, in other words, where only a part of the circumference of the flange portion is joined, stress can be inhibited from being concentrated in the joining portion between the bracket and the exhaust pipe.

In one embodiment of the present disclosure, the support member may have a tubular shape and the exhaust pipe may be provided with a through-hole in an area covered by the bracket.

In such a configuration, an inner space of the support member communicates with an inner space of the exhaust pipe via the bracket. Accordingly, the inner spaces of the bracket and the support member can function as a resonance chamber, whereby air column resonance inside the exhaust pipe can be inhibited.

### BRIEF DESCRIPTION OF THE DRAWINGS

FIG. 1 is a drawing showing an exhaust system support structure according to an embodiment.

FIG. 2 is a sectional view showing the exhaust system support structure according to the embodiment.

FIG. 3 is a sectional view showing an exhaust system support structure according to other embodiment.

### EXPLANATION OF REFERENCE NUMERALS

1, 5 . . . exhaust system support structure, 2, 7 . . . exhaust pipe, 3, 6 . . . support member, 4 . . . bracket, 31 . . . rod-like end, 41 . . . main body of the bracket, 41a . . . large-diameter end, 41b . . . small-diameter end, 41c . . . opening, 42 . . . flange portion, 71 . . . through-hole

### MODE FOR CARRYING OUT THE INVENTION

Hereinafter, example embodiments of the present disclosure will be described with reference to the drawings.

### [1. Configuration]

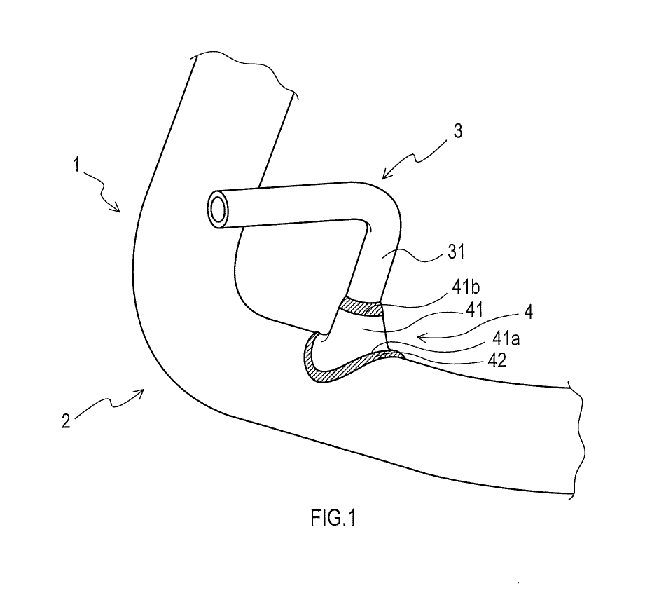

An exhaust system support structure 1 shown in FIG. 1 forms a part of an exhaust flow passage for delivering an exhaust gas emitted from an internal combustion engine of a vehicle to an outside thereof. The exhaust system support structure 1 comprises an exhaust pipe 2, a support member 3, and a bracket 4.

The exhaust pipe 2 is a member for forming the exhaust flow passage. In the present embodiment, the exhaust pipe 2 is a metal tubular member having a circular cross-sectional surface.

The support member 3 is a member for holding the exhaust pipe 2 to a main body of the vehicle. In the present embodiment, the support member 3 is a metal rod-like member having a circular cross-sectional surface and bending in a substantially L-shaped manner.

The support member 3 comprises a rod-like end 31, which is an end in a rod-like shape. The rod-like end 31 is fixed to an outer circumferential surface of the exhaust pipe 2 by the bracket 4. A structure of fixing the support member 3 to the exhaust pipe 2 will be explained below. In the present embodiment, an outer diameter of the sectional surface of the exhaust pipe 2 is larger than that of the cross-sectional surface of the support member 3.

The exhaust pipe 2 is held to the main body of the vehicle by the support member 3 in the following manner. An end of the support member 3, which is not fixed to the outer circumferential surface of the exhaust pipe 2, is fitted into, and thus, fixed to a not-shown hole portion of a rubber material in a substantially plate-like shape. In such a rubber material, another hole portion is arranged and an appropriate rod-like portion, which is joined to the main body of the vehicle, is fitted into, and thus, fixed to the another hole portion. In such a manner, the exhaust pipe 2 is held to the main body of the vehicle with the support member 3.

The bracket 4 is a metal member for fixing the support member 3 to the outer circumferential surface of the exhaust pipe 2. The bracket 4 comprises a main body 41 and a flange portion 42.

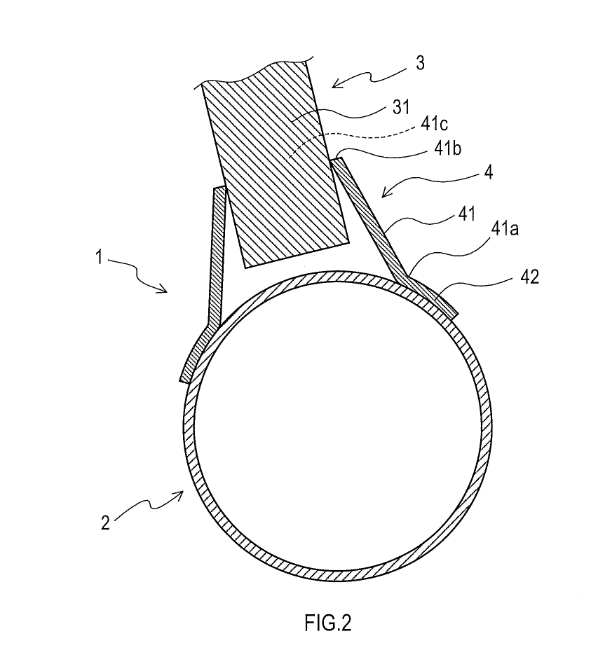

As shown in FIG. 1 and FIG. 2, the main body 41 has a cylindrical shape whose diameter increases gradually. Specifically, the main body 41 is shaped so as to be concentrically widened in plan view and to be trapezoidal in side view. In other words, the main body 41 has a linear slope.

The flange portion 42 is arranged so as to extend outwards from a large-diameter end 41a, which is an end having a larger diameter in the main body 41. In the present embodiment, the flange portion 42 is arranged circularly around a rim portion of the large-diameter end 41a. The flange portion 42 is also arranged at an angle larger than 90 degrees with respect to the main body 41 in side view. The bracket 4 is formed by pressing a flat metal plate.

Next, the structure for fixing the support member 3 to the exhaust pipe 2 will be explained.

As shown in FIG. 1 and FIG. 2, the exhaust pipe 2 and the support member 3 are fixed to each other by joining the support member 3 and one end of the main body 41 of the bracket 4 together and by joining the exhaust pipe 2 and the other end of the main body 41 of the bracket 4 together.

In particular, the support member 3 is joined to a rim portion of an opening 41c of a small-diameter end 41b, which is one end having a smaller diameter in the main body 41 of the bracket 4 shown in FIG. 2, such that the rod-like end 31 is inserted into the opening 41c. On the other hand, at the large-diameter end 41a of the main body 41 of the bracket 4, the flange portion 42 is joined to the outer circumferential surface of the exhaust pipe 2. Specifically, among surfaces of the flange portion 42, a surface arranged to face the outer circumferential surface of the exhaust pipe 2 is entirely in contact with the outer circumferential surface of the exhaust pipe 2 and joined to the outer circumferential surface thereof.

In the present embodiment, an axial circumference of the rod-like end 31 of the support member 3 is entirely welded, and thus, joined to the main body 41 of the bracket 4. Similarly, a circular circumference of the flange portion 42 is entirely welded, and thus, joined to the outer circumferential surface of the exhaust pipe 2. Hatched areas shown in FIG. 1 are welding portions.

As shown in FIG. 2, when the respective members 2 to 4 are joined together, a tip of the rod-like end 31 of the support member 3 and the outer circumferential surface of the exhaust pipe 2 are not in contact with each other. In other words, a space exists between the tip of the rod-like end 31 and the outer circumferential surface of the exhaust pipe 2.

As for a joining order of the respective members 2 to 4, the support member 3 and the bracket 4 are first joined together, and then, the bracket 4 and the exhaust pipe 2 are joined together.

### [2. Effects]

In the above-described embodiment, the following effects can be obtained.

(1) In the configuration of the present embodiment, stress caused when external force is applied to the support member 3 can be dispersed.

For example, the following method could be thought of as a method for fixing the support member 3 to the exhaust pipe 2 without using the bracket 4. The rod-like end 31 of the support member 3 is first bent circumferentially along the outer circumferential surface of the exhaust pipe 2. Then, the rod-like end 31 of the support member 3 is set to come in contact with the outer circumferential surface of the exhaust pipe 2. After that, welding is conducted at several points near a contact portion between the rod-like end 31 and the exhaust pipe 2, whereby the support member 3 and the exhaust pipe 2 are joined together. In such a configuration, however, when external force is applied to the support member 3, stress is likely to be concentrated in the welding points between the exhaust pipe 2 and the support member 3.

In contrast, in a configuration where the bracket 4 is used such as the present embodiment, the diameter of the main body 41 of the bracket 4 gradually increases from the welding portion with the support member 3 toward the welding portion with the exhaust pipe 2. As a result, stress caused by external force, which is applied to the support member 3, can be dispersed.

(2) In the present embodiment, the support member 3 is joined to the rim portion of the opening 41c of the small-diameter end 41b of the bracket 4, such that the rod-like end 31 is inserted into the opening 41c.

For this reason, if a support member has a rod-like end whose diameter is the same as that of the rod-like end 31, even though such a support member is different from the support member 3 in shape in other portions than the rod-like end, the same bracket 4 can be used for fixing the support member to the exhaust pipe 2.

(3) In the present embodiment, the bracket 4 comprises the flange portion 42, and the flange portion 42 is joined to the outer circumferential surface of the exhaust pipe 2.

In such a manner, the bracket 4 can be joined not only to an exhaust pipe whose diameter allows both the bracket 4 and the exhaust pipe to come in contact with each other with no space between the flange portion 42 and an outer circumferential surface of the exhaust pipe, but also to an exhaust pipe having a similar diameter. Accordingly, by using the bracket 4, the support member 3 can be fixed to the exhaust pipe having a similar diameter.

(4) In the present embodiment, the axial circumference of the rod-like end 31 in the support member 3 is entirely welded, and thus, joined to the main body 41 of the bracket 4.

Specifically, in the axial circumference of the rod-like end 31, no end of the welding portion exists. For this reason, as compared with a case where the circumference of the support member 3 is not entirely welded, in other words, where only a part of the circumference of the support member 3 is welded, stress is inhibited from being concentrated in the welding portion between the support member 3 and the bracket 4.

(5) In the present embodiment, the flange portion 42 is circularly arranged along the rim portion of the large-diameter end 41a. The circular circumference of the flange portion 42 is entirely welded, and thus, joined to the outer circumferential surface of the exhaust pipe 2.

However, in the circular circumference of the flange portion 42, no end exists in the welding portion. For this reason, as compared with a case where the circumference of the flange portion 42 is not entirely welded, in other words, where only a part of the circumference of the flange portion 42 is welded, stress is inhibited from being concentrated in the welding portion between the bracket 4 and the exhaust pipe 2.

(6) In the present embodiment, since points to be welded are not many, the cost of welding can be reduced.

Specifically, as a method for fixing the support member 3 to the exhaust pipe 2 without using the bracket 4, provided is the above-described method where the rod-like end 31 of the support member 3 and the outer circumferential surface of the exhaust pipe 2 are set to come in contact with each other and then, joined together. In such a method, in order to make the support member 3 difficult to remove from the exhaust pipe 2, it is conceivable to arrange a rod-like reinforcement member for joining the exhaust pipe 2 and the support member 3 together. Points to be joined in such a method are, for example, six points in total: two points for each of contact portions: between the exhaust pipe 2 and the support member 3 on both sides, between the exhaust pipe 2 and the reinforcement member on both sides, and between the support member 3 and the reinforcement member on both sides.

In contrast, in the present embodiment, welding is performed entirely between the support member 3 and the bracket 4 as well as between the exhaust pipe 2 and the bracket 4, and points to be welded are only two points. Accordingly, the cost of welding can be reduced.

### [3. Other Embodiments]

The embodiment of the present disclosure has been described above. However, the present disclosure is not be limited by the aforementioned embodiment, and can be practiced in various manners.

(1) In the aforementioned embodiment, the main body 41 of the bracket 4 is shaped so as to be concentrically widened in plan view and to have a linear slope. However, the shape of the bracket is not be limited by such a shape. A bracket, for example, may have a shape with a central axis of a bracket main body gradually shifting, or other shapes. The main body of the bracket, for example, may have a curvilinear slope.

(2) In the aforementioned embodiment, the welding is entirely performed at the circumference between the exhaust pipe 2 and the bracket 4 as well as at the circumference between the support member 3 and the bracket 4. However, the welding method is not be limited by such welding. For example, at least either one of the circumferences, between the exhaust pipe 2 and the bracket 4 or between the support member 3 and the bracket 4, may be entirely or partly welded.

(3) In the aforementioned embodiment, the joining of the exhaust pipe 2 and the bracket 4 as well as that of the support member 3 and the bracket 4 is performed by welding. However, a joining method is not be limited by such joining. For example, the exhaust pipe 2 and the bracket 4, and the like, may be joined by brazing.

(4) In the aforementioned embodiment, when the respective members 2 to 4 are joined together, the tip of the rod-like end 31 of the support member 3 and the outer circumferential surface of the exhaust pipe 2 are not in contact with each other. However, a joining structure is not be limited by such a structure. For example, the respective members 2 to 4 may be joined together such that the tip of the rod-like end 31 of the support member 3 and the outer circumferential surface of the exhaust pipe 2 are in contact with each other.

(5) In the aforementioned embodiment, described as an example is the configuration where the support member 3 and the bracket 4 are first joined together, and then, the bracket 4 and the exhaust pipe 2 are joined together. However, a joining order of the respective members 2 to 4 is not be limited by such a configuration. For example, the bracket 4 and the exhaust pipe 2 may be first joined together, and then, the bracket 4 and the support member 3 may be joined together.

(6) In the aforementioned embodiment, the bracket 4 is formed by pressing the flat metal plate. However, a manufacturing method of the bracket 4 is not be limited by such manufacturing. For example, the bracket 4 may be formed by processing a metal cylindrical member.

(7) A function for inhibiting air column resonance, which occurs when the exhaust gas emitted from the internal combustion engine of the vehicle passes inside the exhaust pipe, may be added to the exhaust system support structure 1 of the aforementioned embodiment.

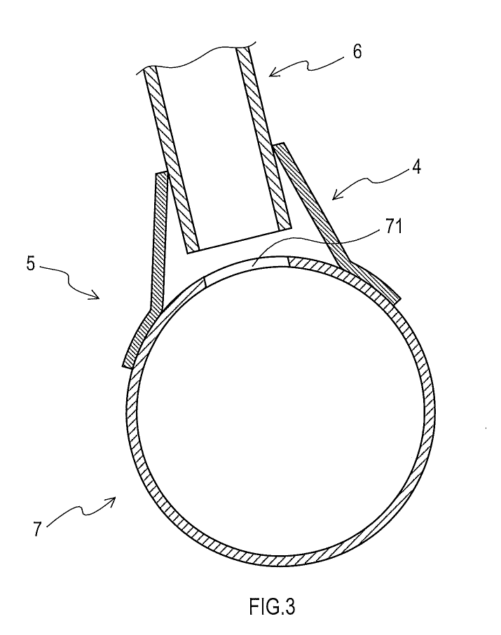

For example, an exhaust system support structure 5 shown in FIG. 3 comprises the bracket 4, a support member 6, and an exhaust pipe 7. Although the support member 3 has a rod-like shape, the support member 6 has a tubular shape. The exhaust pipe 7 is different from the exhaust pipe 2 in an aspect that the exhaust pipe 7 is provided with a through-hole 71 in an area covered by the bracket 4. In other words, in a configuration shown in FIG. 3, an inner space of the support member 6 communicates with an inner space of the exhaust pipe 7 via the bracket 4.

The through-hole 71 is arranged at a position where the maximum sound pressure of the air column resonance is applied. For example, the through-hole 71 may be arranged at a position where the maximum sound pressure of the third resonant mode is applied, that is, at one-sixths of a pipe length from a downstream-side opening of the exhaust pipe 7, at three-sixths (one-seconds), or at five-sixths. Also, the through-hole 71 may be arranged at a position where the maximum sound pressure of the second resonant mode is applied, that is, at one-fourths of the pipe length from the downstream-side opening or at three-fourths. The through-hole 71 may also be arranged at a position where the maximum sound pressure of the first resonant mode is applied, that is, at one-seconds of the pipe length from the downstream-side opening.

In such a configuration, the inner spaces of the bracket 4 and the support member 6 can function as a resonance chamber, whereby the air column resonance inside the exhaust pipe 7 can be inhibited. In particular, at least air column resonance sounds of the first mode to the third mode (the modes highly needing to be sound-muffled) can be inhibited.

It is conceivable to arrange a sub muffler in series with a main muffler in order to inhibit the air column resonance. However, in the configuration shown in FIG. 3, since the air column resonance can be inhibited by the through-hole arranged in the exhaust pipe, the cost of measures taken against the air column resonance can be reduced.

(8) Functions of one constituent element in the aforementioned embodiment may be divided and separately performed by a plurality of constituent elements, or functions of a plurality of constituent elements may be integrated and performed by one constituent element. Part of the configuration in the aforementioned embodiment may be omitted. Addition, replacement, etc., of at least part of the configuration in the aforementioned embodiment may be carried out with respect to the configuration in the aforementioned other embodiment. Any modes included in the technical ideas specified by the languages of the claims are embodiments of the present disclosure.

1. An exhaust system support structure comprising:
an exhaust pipe forming an exhaust flow passage;
a bracket; and
a support member fixed to an outer circumferential surface of the exhaust pipe with the bracket,
wherein the bracket comprises: a main body having a cylindrical shape, whose diameter increases gradually; and a flange portion arranged so as to extend outwards from a large-diameter end, which is an end having a larger diameter in the main body,
wherein the flange portion is joined to the outer circumferential surface of the exhaust pipe,
wherein the support member comprises a rod-like end, which is an end in a rod-like shape, the support member being joined to a rim portion of an opening of a small-diameter end, which is one end having a smaller diameter in the main body, such that the rod-like end is inserted into the opening.

2. The exhaust system support structure according to claim 1,
wherein in the support member, an axial circumference of the rod-like end is entirely joined to the main body.

3. The exhaust system support structure according to claim 1,
wherein the flange portion is arranged circularly around a rim portion of the large-diameter end and in the flange portion, a circular circumference is entirely joined to the outer circumferential surface of the exhaust pipe.

4. The exhaust system support structure according to claim 1,
wherein the support member has a tubular shape and the exhaust pipe is provided with a through-hole in an area covered by the bracket.

5. The exhaust system support structure according to claim 2,
wherein the flange portion is arranged circularly around a rim portion of the large-diameter end and in the flange portion, a circular circumference is entirely joined to the outer circumferential surface of the exhaust pipe.

6. The exhaust system support structure according to claim 2,
wherein the support member has a tubular shape and the exhaust pipe is provided with a through-hole in an area covered by the bracket.

7. The exhaust system support structure according to claim 3,
wherein the support member has a tubular shape and the exhaust pipe is provided with a through-hole in an area covered by the bracket.

8. The exhaust system support structure according to claim 5,
wherein the support member has a tubular shape and the exhaust pipe is provided with a through-hole in an area covered by the bracket.
